(19) United States
(12) Patent Application Publication
(10) Pub. No.: US 2007/0086035 A1
(43) Pub. Date: Apr. 19, 2007

(54) Printer controller apparatus implemented as a system in a package

(76) Inventors: Thomas Omega Wheless JR., Eagle, ID (US); Greg Lee Allen, Boise, ID (US); Randall Don Briggs, Boise, ID (US); Mark David Montierth, Meridian, ID (US); Michael David Cusack, Boise, ID (US)

Correspondence Address: BRINKS HOFER GILSON & LIONE/MARVELL, P.O. BOX 10395, CHICAGO, IL, 60610, US

(21) Appl. No.: 11/253,317

(22) Filed: Oct. 19, 2005

(51) Int. Cl. G06F 3/12

(52) U.S. Cl. 358/1.13

(57) ABSTRACT

A printer device includes a printer engine controller in communication with a print mechanism and a printer formatter. The printer formatter includes a quad flat pack (QFP) package having an application specific integrated circuit (ASIC) mounted and a memory device mounted therein. The printer device further includes a substrate having the QFP package and the printer engine controller mounted thereon.

### BACKGROUND

The present invention relates generally to integrated circuit devices, and, more particularly, to a printer controller apparatus (e.g., printer controller, formatter) implemented as a system in a package.

Conventional printer controller systems (or “formatters”) are typically implemented as discrete printed circuit assemblies (PCA's). These types of PCA-packaged formatters feature an embedded controller in the form of a custom Application Specific Integrated Circuit (ASIC) that takes high-level page description languages and renders the same into a set of discrete points (i.e., “pixels”) that are then sent to a separate marking engine controller within the printer. The custom ASIC typically has a single SOC (system on a chip), as well as a discrete set of volatile and non-volatile memories, for example.

Thus configured, a conventional printer controller system is dependent upon a complete manufacturing supply chain with respect to the manufacture of separate printer controller boards and engine controller substrates. Moreover, such discrete internal printer components limit the placement of the same within the printing device. In addition, the large amount of interconnect associated with the separate formatter and engine boards increases the packaging costs and limits the flexibility with regard to the available materials for the printed circuit boards.

Accordingly, it would be desirable to be able to provide a complete printer controller system implemented in a manner that offers decreased packaging costs, as well as increased flexibility with regard to area placement and PCB material selection.

### SUMMARY

A printer formatter device of the present invention is presented. The printer formatter device includes a quad flat pack (QFP) package having an application specific integrated circuit (ASIC) mounted and a memory device mounted therein.

A printer device of the present invention is also presented. The printer device includes a printer engine controller in communication with a print mechanism and a printer formatter. The printer formatter includes a quad flat pack (QFP) package having an application specific integrated circuit (ASIC) mounted and a memory device mounted therein. The printer device further includes a substrate having the QFP package and the printer engine controller mounted thereon.

The above described and other features will be appreciated and understood from the following detailed description, drawings, and appended claims.

### BRIEF DESCRIPTION OF THE DRAWINGS

Referring now to the figures, which are exemplary embodiments, and in which like elements are numbered alike:

FIG. 1 is a schematic block diagram of a conventional printer formatter manufactured on a printer circuit board;

FIG. 2 is a schematic block diagram of another conventional printer formatter manufactured on a printer circuit board;

FIG. 3 is a schematic block diagram of a printer, including the conventional printer formatter shown in FIG. 1;

FIG. 4 is a schematic diagram of a printer formatter manufactured within a quad flat pack (QFP) packaging arrangement, in accordance with an embodiment of the present invention;

FIG. 5 is a more detailed view of the QFP printer formatter of FIG. 4; and

FIG. 6 is a schematic block diagram of a printer, including the QFP printer formatter shown in FIGS. 4 and 5 mounted on the same board as a printer engine controller, in accordance with a further embodiment of the present invention.

### DETAILED DESCRIPTION

Referring to FIG. 1, a conventional printer formatter 100 manufactured on a printer circuit board 102 in accordance with the prior art is generally shown. The printer formatter 100 includes a custom Application Specific Integrated Circuit (ASIC) 104, a microprocessor 106, memory (e.g., dynamic random access memory (DRAM)) 108, a print engine interface 110, and an input/output (I/O) interface 112 to/from the ASIC 104. The ASIC 104 is configured to perform such tasks as receiving a print job from the I/O port, converting a print job from a received format to a format useable by a print engine (not shown), and compressing or decompressing a print job. The individual printer formatter components are implemented through discrete chips mounted on the formatter circuit board 102. The circuit board 102 is comprised of a glass fiber epoxy laminate material, i.e., FR4. FR4 is a relatively expensive circuit board material, as compared to, for example, phenolic paper grades FR1 and FR2 that are commonly used in the mass production of various consumer electronic goods. FR4 printed circuit board is used to accommodate the high-speed requirements of interfaces 114 and 116, between ASIC 104 and DRAM 108, and between ASIC 104 and microprocessor 106, respectively.

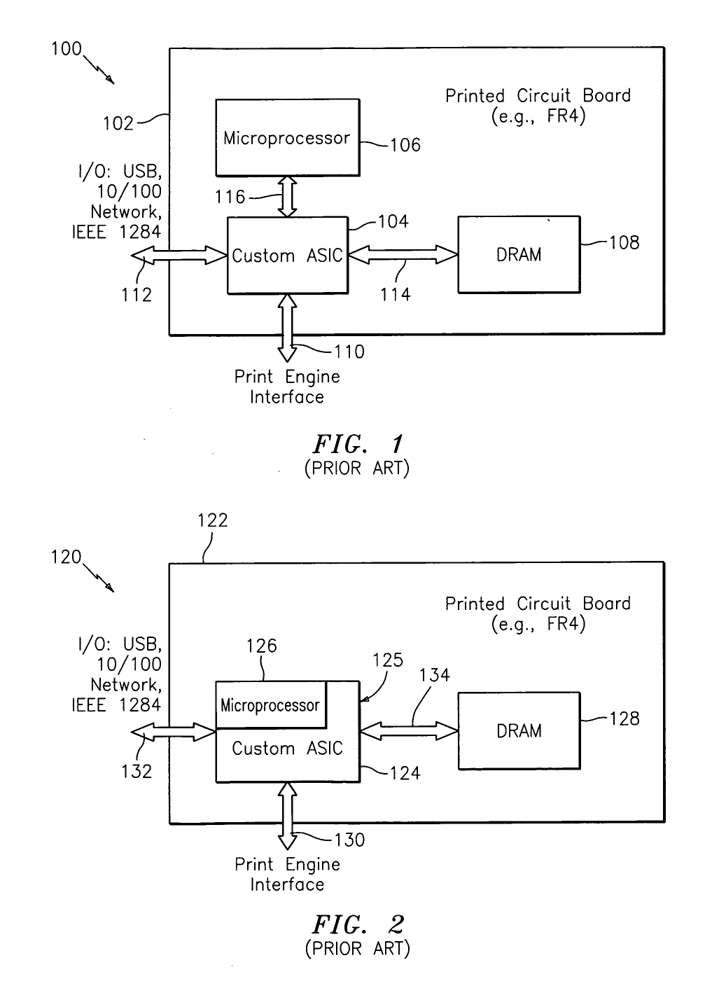

Referring to FIG. 2, another conventional printer formatter 120 manufactured on a printer circuit board 122 in accordance with the prior art is generally shown. The printer formatter 120 combines the functionality of an ASIC 124 and a microprocessor 126 into a single chip 125. The printer formatter 120 includes the ASIC 124 with the integrated microprocessor 126, memory (e.g., DRAM) 128, a print engine interface 130, and an input/output (I/O) interface 132 to/from the ASIC 124. The ASIC 124 is configured to perform such tasks as receiving a print job from the I/O port, converting a print job from a received format to a format useable by a print engine (not shown), and compressing or decompressing a print job. The individual printer formatter components are implemented through discrete chips mounted on the formatter circuit board 122. Again, the circuit board 122 is comprised of a glass fiber epoxy laminate material, i.e., FR4. However, the FR4 printed circuit board is still used to accommodate the high-speed requirements of interface 134 between ASIC 124/microprocessor 126 (i.e., chip 125) and DRAM 128.

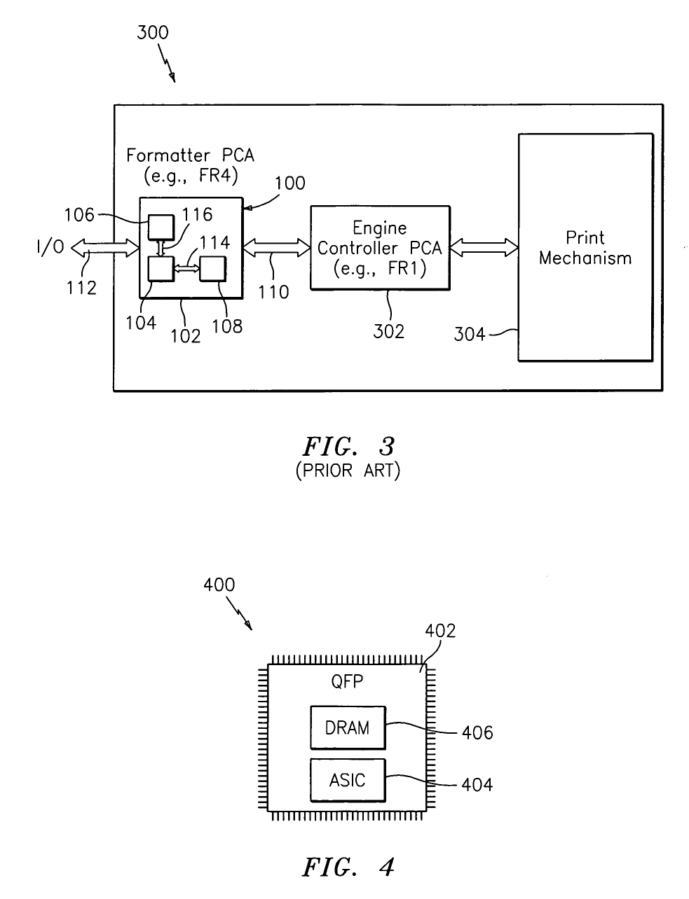

Referring to FIG. 3 a conventional printer 300 in accordance with the prior art is generally shown. The printer 300 is shown utilizing the printer formatter 100 of FIG. 1. The same configuration would be applicable to the utilization of the printer formatter 120 of FIG. 2. The printer 300 further includes a printer engine controller 302 and a print mechanism 304. The printer engine controller 302 receives a print job in a format generated by the printer formatter 100 and causes the print mechanism 304 to form images on a recording medium (not shown). The print mechanism 304 typically comprises a laser print mechanism or an inkjet print mechanism.

As indicated above, the printer formatters of the present printer configurations are manufactured on expensive FR4 substrates. Moreover, the use of the discrete board further limits the placement of the printer formatter components within the printer housing.

Referring now to FIG. 4 a printer formatter package 400 in accordance with an embodiment of the present invention is generally shown. The printer formatter package 400 is manufactured in a quad flat pack (QFP) packaging 402. The QFP package 402 includes a custom ASIC 404 and memory (e.g., DRAM) 406. The ASIC 404 has a microprocessor incorporated therein. In an alternative embodiment the QFP package 402 is separate from the microprocessor (not shown).

While the QFP package 402 may be configured as a single chip that combines the ASIC functionality, microprocessor functionality, and the memory functionality, such a chip is presently limited in terms of the speed at which the signals are processed, owing to its fabrication in an integrated circuit technology that is compatible with DRAM. With such a configuration, the ASIC and microprocessor portion of would be larger in the DRAM process than for a process tuned for high-speed logic. In contrast, the present invention as shown in the embodiment of FIG. 4 benefits from having the DRAM functionality fabricated in its native process, while the ASIC and microprocessor are fabricated in their native processes, yet achieves the benefits of combining all three functions into a single package.

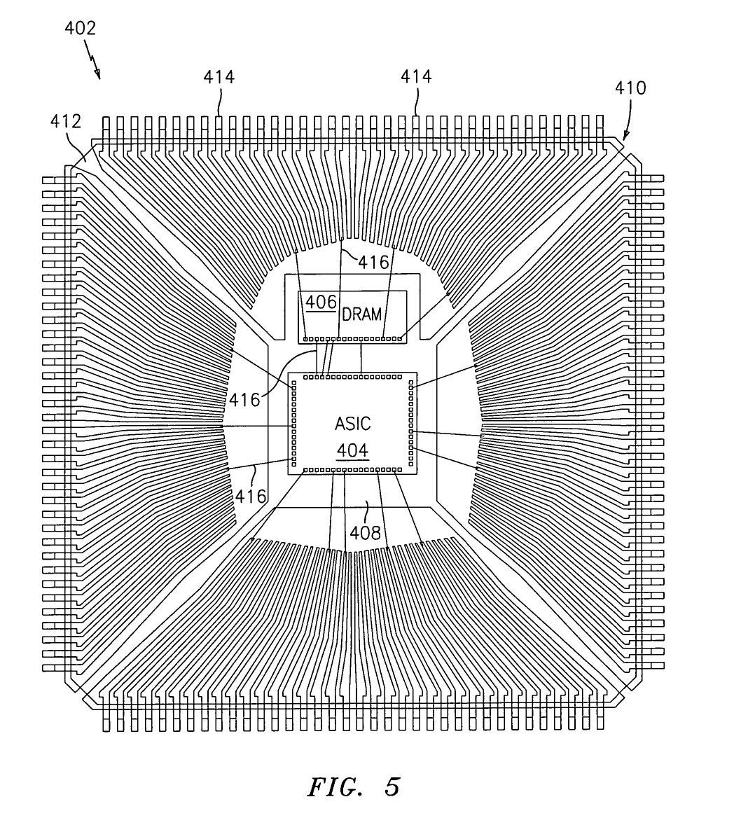

Referring to FIG. 5, the QFP package 402 is shown in more detail. The QFP package 402 has a generally centrally located die paddle 408, which is part of a thin metal lead frame 410. The lead frame 410 is, typically, stamped or chemically etched from strips or sheets of copper-containing materials. The die paddle 408 is generally rectangular in shape and is supported by radially extending support beams 412. The ASIC 404 and DRAM 406 are mounted directly to the die paddle 408.

The lead frame 410 further includes a plurality of thin, closely spaced conductive leads 414 whose inner ends radially extend away from the edges of the ASIC 404 and DRAM 406 chips. The inner ends of the conductive leads are also referred to as bonding fingers. Very small diameter, gold bonding wires 416 have one end thereof bonded to corresponding bonding pads on both the integrated-circuit die 404 and DRAM 406, and the other end thereof bonded to the corresponding bonding fingers 414. The wires 416 are also used to make direct connections between bonding pads of the ASIC 404 and DRAM 406. In an exemplary embodiment, the DRAM 406 is a known good die (KGD); i.e., the die has successfully passed wafer-level testing.

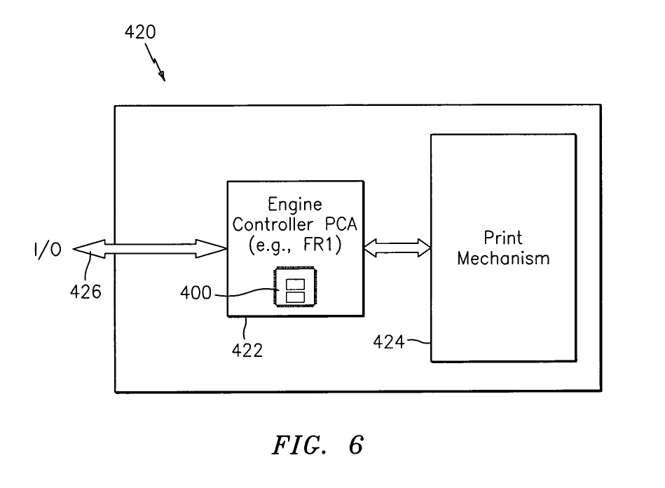

Referring to FIG. 6, a printer 420 in accordance with an embodiment of the present invention is generally shown. The printer 420 utilizes the printer formatter 400 of FIGS. 4 and 5. The printer 420 further includes a printer engine controller 422 and a print mechanism 424. The printer engine controller 422 receives a print job in a format generated by the printer formatter 400 and causes the print mechanism 424 to form images on a recording medium (not shown). The print mechanism 424 typically comprises a laser print mechanism or an inkjet print mechanism. An I/O interface 426 of is provided and may be any type of wired or wireless connection including, but not limited to: a 10/100 (Ethernet) connection, a Universal Serial Bus (USB) connection, and an IEEE 1284 parallel connection, for example.

Instead of a discrete FR4 circuit board as described in the prior art configurations of FIGS. 1-3, this embodiment of the present invention utilizes the same substrate for the printer formatter 400 (the QFP package 402) and the printer engine controller 422. This substrate is comprised of phenolic paper grades FR1, which as previously discussed is less expensive than FR4. This is possible because the high-speed interface between the ASIC 404 and DRAM 406 is found in the QFP package 402. In this manner, a space savings is achieved, which further allows flexibility in the placement of additional printer components, as well as a cost savings in the elimination of a separate mounting substrate for the formatter components. Additionally, improved signal transmission speed is realized as a result of the shorter connection distances.

The printer configuration described herein is both economical and flexible in material selection, in that it is provided as a complete “system in a package.” Notably, other types of packaging, such as a ball grid array (BGA), are not suitable for use on a paper phenolic PCB. Moreover, the less expensive substrate may also include additional printer components, such as an engine controller, for example, thereby providing more efficient product packaging of the device as a whole.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A printer formatter device, comprising:
a quad flat pack (QFP) package;
an application specific integrated circuit (ASIC) mounted within the QFP package; and
a memory device mounted within the QFP package.

2. The printer formatter device of claim 1, wherein the QFP package further comprises a lead frame and a die paddle forming a part of the lead frame, the memory device mounted to said die paddle, and further comprising:
a plurality of bond wires connecting the ASIC and the memory device to the QFP package.

3. The printer formatter device of claim 1, wherein the ASIC and the memory device each comprise discrete chips.

4. The printer formatter device of claim 3, wherein the ASIC comprises a microprocessor element.

5. The printer formatter device of claim 3 wherein the memory device comprises a DRAM.

6. The printer formatter device of claim 5, wherein the DRAM further comprises a known good die (KGD).

7. A printer device, comprising:
a printer engine controller;
a print mechanism in communication with the printer engine controller;
a printer formatter also in communication with printer engine controller, the printer formatter comprising,
a quad flat pack (QFP) package,
an application specific integrated circuit (ASIC) mounted within the QFP package, and
a memory device mounted within the QFP package; and
a substrate having the QFP package and the printer engine controller mounted thereon.

8. The printer device of claim 7, wherein the substrate comprises phenolic paper.

9. The printer device of claim 8, wherein said phenolic paper further comprises FR1.

10. The printer device of claim 7, wherein the QFP package further comprises a lead frame and a die paddle forming a part of the lead frame, the memory device mounted to said die paddle, and further comprising:
a plurality of bond wires connecting the ASIC and the memory device to the QFP package.

11. The printer device of claim 7, wherein the ASIC and the memory device each comprise discrete chips.

12. The printer device of claim 11, wherein the ASIC comprises a microprocessor element.

13. The printer device of claim 11 wherein the memory device comprises a DRAM.

14. The printer device of claim 13, wherein the DRAM further comprises a known good die (KGD).
